(19) United States
(12) Patent Application Publication
(10) Pub. No.: US 2006/0032025 A1
(43) Pub. Date: Feb. 16, 2006

(54) Towel bar with escutcheons

(75) Inventor: Joseph D. Hendrickson, University Heights, IA (US)

Correspondence Address: MCKEE, VOORHEES & SEASE, P.L.C., 801 GRAND AVENUE, SUITE 3200, DES MOINES, IA, 50309-2721, US

(73) Assignee: Custom Hardware Mfg., Inc., Keokuk, IA (US)

(21) Appl. No.: 11/201,224

(22) Filed: Aug. 10, 2005

Related U.S. Application Data
(60) Provisional application No. 60/600,710, filed on Aug. 10, 2004.

(51) Int. Cl. E05B 1/00

(52) U.S. Cl. 16/444

(57) ABSTRACT

An escutcheon for use with a clamping assembly to mounting a device to a surface. The escutcheon is placed over an exposed fastener for connecting the two clamping members once connected on opposite sides of the surface. The cover member is an escutcheon for covering direct sight of the fastening member from that side.

### PRIORITY STATEMENT

This application claims priority to U.S. Provisional Patent Application No. 60/600,710, filed Aug. 10, 2004, herein incorporated by reference in its entirety.

### BACKGROUND OF THE INVENTION

A. Field of the Invention

The present invention relates to any type of bar or pull other hardware that is mounted to one side of a door or surface and which has hardware that attaches it by clamping to the opposite side of the door, panel, or surface. In particular, the invention relates to a method, apparatus, and system of mounting such a device and finishing the mounting structure on the opposite side of the bar or pull.

B. Prior Art

As can be appreciated, in some instances hardware for doors, walls, or panels is attached by a clamping combination. For example, please refer to FIG. 1 (attached). This arc shaped towel bar 10 has opposite ends 12 and 14. Ends 12 and 14 are flat and have a tapped bore 16 adapted to receive the end of a threaded screw. Towel bar 10 is meant to fit against a surface such as, for example, a glass panel or door (e.g., a shower panel or shower door). To fix towel bar 10 to such a panel, two holes are drilled in the glass panel. On the opposite side of the glass panel a bolt or screw would be positioned in the washer, directed through the hole in the glass, and then threaded into the threaded aperture 16 for both ends 12 and 14 of the towel bar 10. By screwing the screws into apertures 16, towel bar 10 would thus be clamped to the glass panel or door.

As can be further appreciated, the head of the screws on the side of the glass panel opposite towel bar 10 would be visible once the bar is installed. In situations where that side of the panel or door is visible, this detracts from the aesthetic appearance of the combination.

### SUMMARY OF THE INVENTION

The present invention relates to a method, apparatus, and system of installing the type of hardware described above which eliminates direct sight of the screw or other attachment hardware for clamping the bar or pull to the surface or panel. In one exemplary embodiment, a cover member is adapted to fit over all or a portion of the screw or fastener and/or all or a portion of a washer or other component that is on the opposite side of the bar or pull. The cover covers direct sight of the fastener and/or that structure.

### BRIEF DESCRIPTION OF THE DRAWINGS

FIG. 1 is a side elevation of a towel bar according to one exemplary embodiment of the present invention.

FIG. 2 is a bottom plan view of FIG. 1.

FIG. 3A is a plan view of the outer side of a fastener pad adapted for clamping the towel bar of FIGS. 1 and 2 to a panel or door, on the opposite side of the towel bar.

FIG. 3B is a side elevation of FIG. 3A.

FIG. 3C is an end elevation of FIG. 3A.

FIG. 4 is a top plan view of a cover adapted for connection over the top of the fastener pad of FIG. 3A to cover from sight the fastener and the structure of the fastener pad in FIG. 3A.

FIG. 5A is side elevational sectional view of an exploded version of an exemplary embodiment of the invention.

FIG. 5B is a perspective view of the embodiment of FIG. 5A.

FIG. 6A is similar to FIG. 5A but shows the assembly assembled except for the escutcheon that covers the fastener on the exposed side of the panel.

FIG. 6B is a perspective vie of FIG. 6A, showing better how fasteners are exposed before the escutcheons are mounted over them.

### DETAILED DESCRIPTION OF THE EXEMPLARY EMBODIMENT

For a better understanding of the invention, one specific example will now be described. The example relates to a towel bar adapted to fit on one side of a glass panel or door such as a shower door for a residential bathroom. It is to be understood, however, that the invention has equal applicability to other types of hardware. A few examples include towel bars of other shapes and configurations, shower door handles, and decorative structure that is attached to glass panels or doors, etc. Furthermore, the invention is not limited to glass paneled doors or glass panels. It applies to a mounting structure where the hardware is on one side of some surface and it is attached by clamping through the surface where there is a screw or bolt or other fastener that extends through the surface and into the hardware to clamp it.

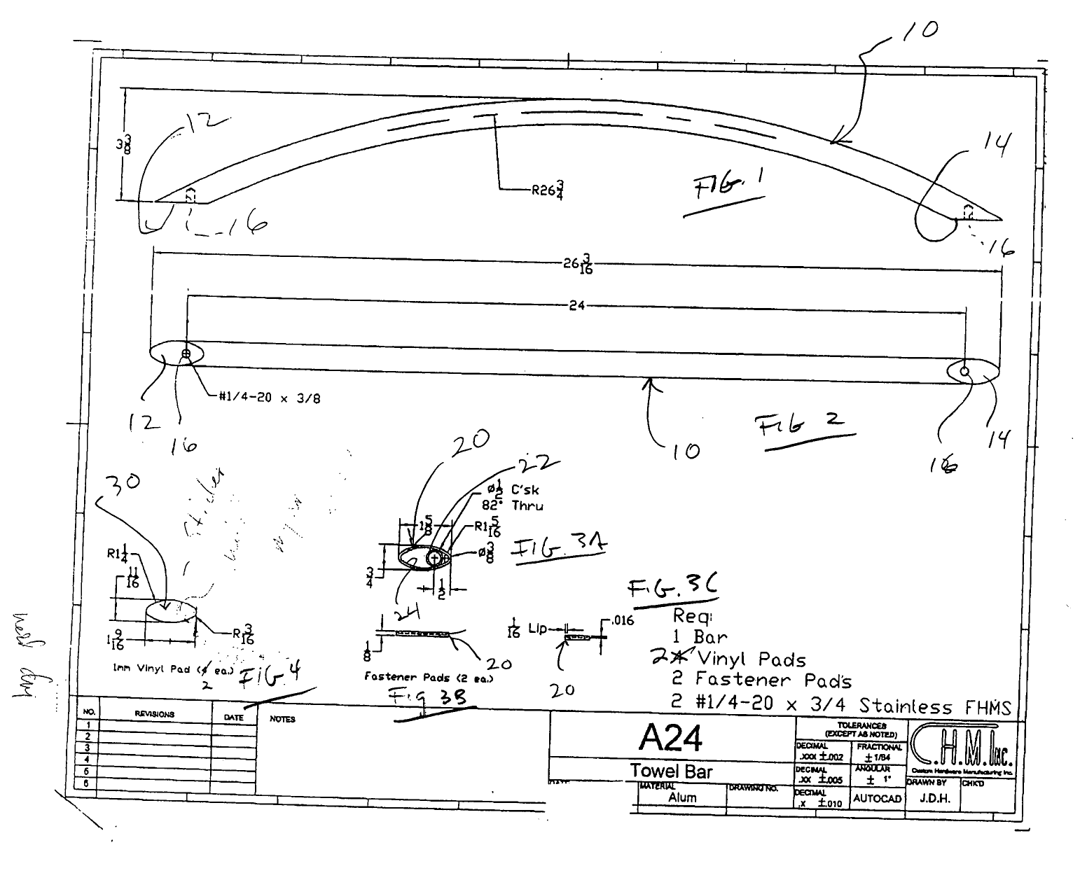

With respect to the example shown in FIGS. 1-4, towel bar 10 has opposite ends 12 and 14 which have essentially flat surfaces that are aligned in a plane. Tapped bore 16 extend perpendicularly into ends 12 and 14 of bar 10 from those flat surfaces. Bar 10 is adapted to fit against one side of a surface, here a glass panel or door of sheet or panel form.

As shown in FIG. 1, bar 10 is arc shaped. It could take any number of different forms or embodiments. FIG. 2 shows bores 16 and indicates this particular thread type and bore size.

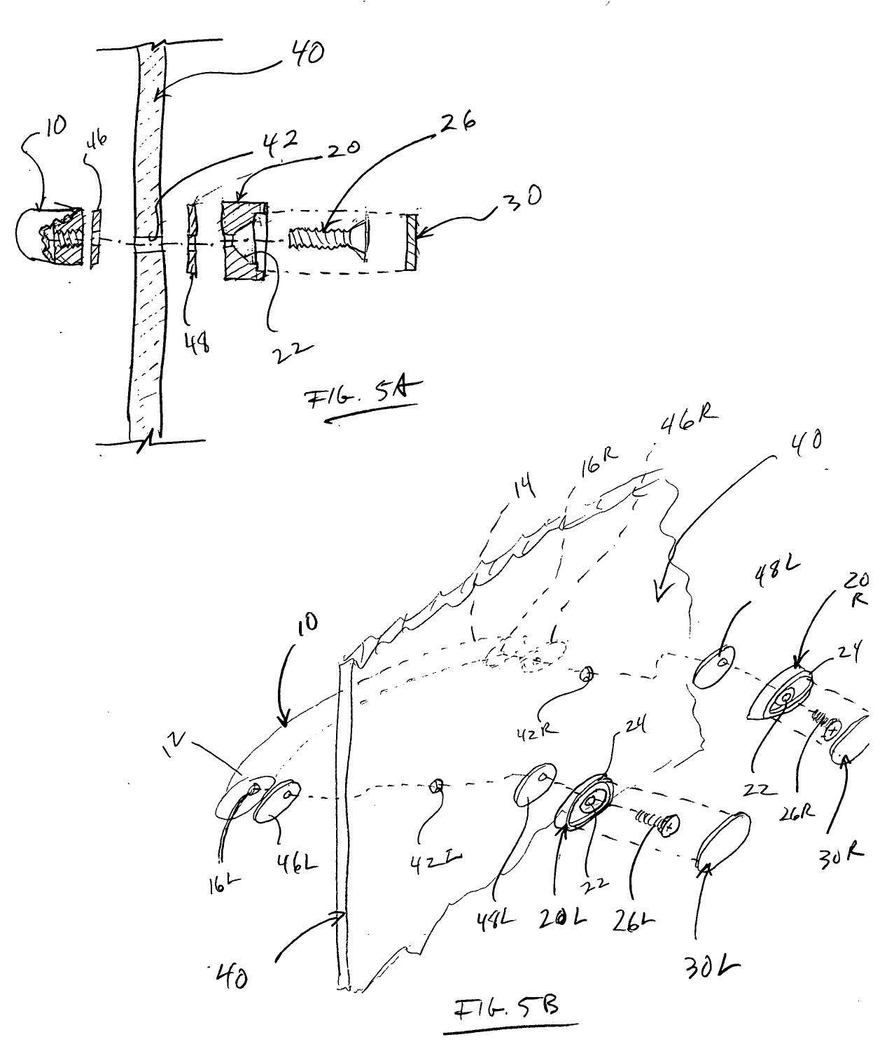

FIGS. 3A-C illustrate in detail what will be called a fastener pad 20. It could be made of any number of material (e.g., metal or hard rubber). It needs to be strong enough that it can receive the indicated screw or bolt through the indicated hole (see FIG. 3A) and (with the heads of screws) clamp bar 10 to the glass panel while essentially acting as a clamp on the opposite sides of flattened ends 12 and 14 of bar 10. As can be seen, in this embodiment fastener pad 20 is made of the same oval shape as ends 12 and 14 of bar 10. Two fastener pads 20 L and R (left and right) would be used, one for each end 12 and 14 of bar 10. They would just be rotated 1800 from one another to match up their holes 22 with hole 16 in bar 10.

Even though fastener pads 20 are relatively thin (see FIGS. 3B and 3C) and match the shape of ends 12 and 14 of bar 10, the head of the screws used to clamp bar 10 to the surface through pads 20 would be exposed to view. Also, the head of the fastening screw would be exposed to water and the other environmental substances typical for that installation (e.g., cleaning chemicals, soaps, hair products, etc).

FIG. 4 illustrates what is called cover 30. As shown, it is shaped such that it fits over the head of the screw in opening 22 in fastener pad 20. In this embodiment, fastener pad 20 has a raised edge 24 around its perimeter. Cover 30 can have a perimeter that is slightly smaller than the inside perimeter of raised edge 24 so that it matingly fits within that edge 24. It then covers substantially fastener pad 20 including the exposed head of the screw. Cover 30 therefore is a much more aesthetically pleasing configuration and provides some resistance to water or chemicals that would otherwise be experienced by fastener pad 20 and its screw.

In this exemplary embodiment, the dimensions of cover 30 relative to fastener pad 20 are indicated on FIGS. 3A-C and FIG. 4. The composition of cover 30 can vary. In this embodiment, it is essentially a one millimeter thick vinyl pad. It is mylar allowing it to be somewhat flexible but durable with a metallic layer on its outer surface. It could be other materials (e.g., metal to match part 20). It can be adhesively mounted into fastener pad 20. The adhesive would be one that would maintain its adherence even through the years of conditions related to a shower environment.

Alternatively, of course, cover 30 could be configured to have a perimeter that matches or fit over the outer perimeter dimensions of fastener pad 20 and be adhered on top of that edge 24. It could also perhaps be interference fit within edge 24.

It does not have to have a metallic coating. It could be made of different materials of different properties.

Essentially cover 30 is an escutcheon.

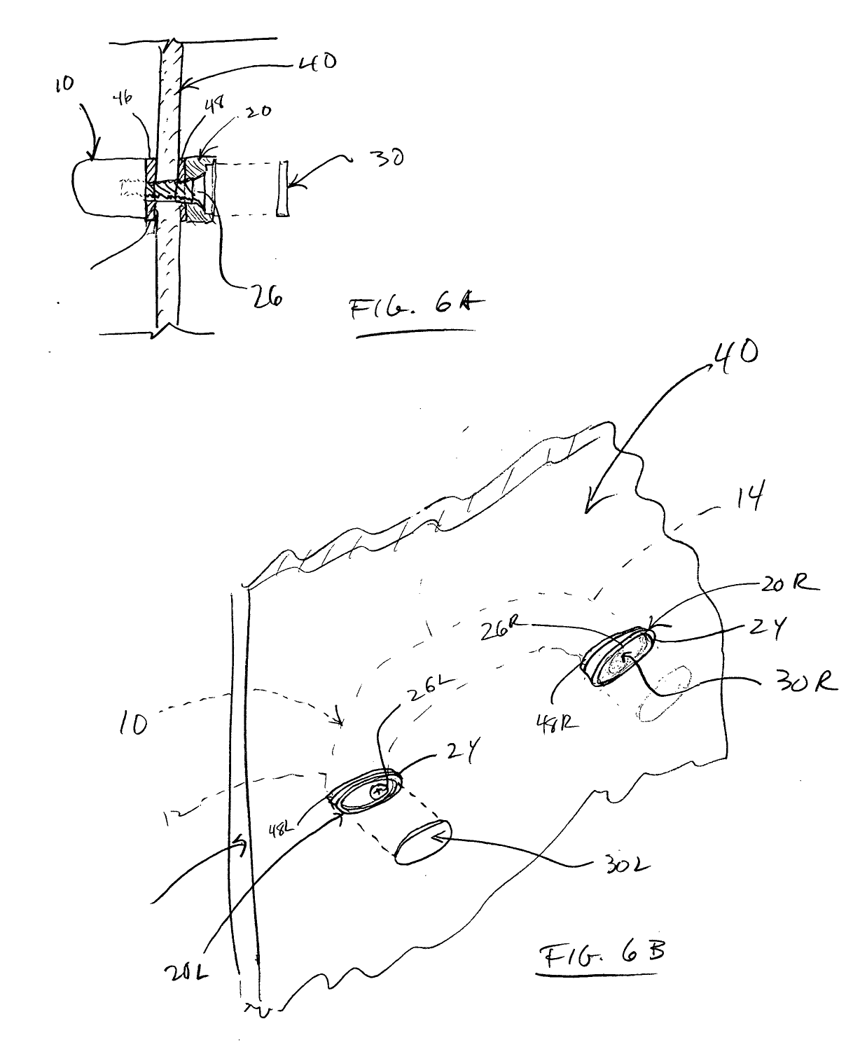

FIG. 5A shows an elevational sectional view another view of the parts but relative to a glass pane 40. FIG. 5B shows the combination from a perspective view. Two holes 42 L and R are drilled or formed in glass pane 40 to match and align with threaded aperture 16 L and R of towel bar 10. Optionally plastic washers 46 and 48 can be inserted on opposite sides of openings 42 L and R and themselves have openings that can be aligned with the opening in the opening 16 L and R.

Fastener pads 20 L and R have countersinks to receive machine screw 26 such that its head is recessed from the outer surface of fastener pad 20. Covers 30 then are shaped to fit within edge 24 of fastener pads 20. FIG. 6A and B show how the combination, except for cover pads 30, can be mounted on a glass panel. In particular, FIG. 6B illustrates that when the parts, except for covers 30 L and R are installed on the glass panel, the heads of machine screws 26 L and R would be visible from the side of glass panel 40 shown in FIG. 6B. Cover or escutcheon 30 is place able and securable over fasteners 26 L and R (see right side of FIG. 6B) to cover the machine screw 26 R to give it a much more pleasing and aesthetic appearance.

As can be appreciated, variations obvious to those skilled in the art can be included within the present invention. Covers 30 L and R could be made of material that matches the color and material and configuration of fastener pads 20 L and R. It could have adhesive preapplied with a release sheet such that they could simply be quickly installed on site.

It can be appreciated that cover 30 can take many forms and configurations and may just cover the fastener or cover substantial part or all of cover pad 20. They could be made of different materials and colors or textures.

What is claimed:

1. A mounting assembly for clamping the device to a surface comprising:
a mounting pad adapted for abutment with one side of the surface;
a mounting portion on the device adapted for abutment with the opposite side of the surface;
a fastener adapted for insertion through the mounting pad, an aperture in the surface, and into the mounting portion on the device;
a cover member adapted to be mounted over an exposed portion of the fastener on the mounting pad when the mounting assembly is assembled.

2. The mounting assembly of claim 1 wherein the device comprises hardware.

3. The mounting assembly of claim 2 wherein the hardware comprises a towel bar.

4. The mounting assembly of claim 2 wherein the hardware comprises a pull.

5. The mounting assembly of claim 2 wherein the hardware comprises a hook.

6. The mounting assembly of claim 1 wherein the mounting pad comprises a perimeter and an aperture through the mounting pad.

7. The mounting assembly of claim 6 wherein the mounting pad further comprises a raised edge.

8. The mounting assembly of claim 1 wherein the fastener comprises a threaded fastener.

9. The mounting assembly of claim 8 wherein the threaded fastener is a machine screw.

10. The mounting assembly of claim 8 wherein the mounting portion of the device comprises a threaded bore.

11. The mounting assembly of claim 1 wherein the cover member has a perimeter and is relatively thin in cross section.

12. The mounting assembly of claim 1 wherein the cover member has an adhesive on one side.

13. The mounting assembly of claim 1 wherein the cover member is interference fit to the mounting portion of the device.

14. The mounting assembly of claim 1 wherein the cover member is configured to cover the fastener and/or part of the mounting portion of the device.

15. An escutcheon for use with a clamping assembly for mounting a device to a surface, comprising:
(a) a relatively thin in cross section member;
(b) cover member adapted to be mounted on the clamp assembly to cover fastening components from sight.

16. A method of mounting a device to the surface by having clamping members on opposite sides of the surface and attaching the clamping members with a fastener having a portion exposed to view, comprising: after assembly covering the exposed portion of the fastener.

17. The method of claim 16 wherein the cover is configured to match the clamp member to which it is attached.
